(19) United States
(12) Patent Application Publication
(10) Pub. No.: US 2015/0278711 A1
(43) Pub. Date: Oct. 1, 2015

(54) SYSTEM STATE CLASSIFIER

(71) Applicant: Lancaster University Business Enterprises Ltd., Lancaster (GB)

(72) Inventors: Plamen ANGELOV, Lancaster (GB); Denis Georgiov KOLEV, Lancaster (GB); Garegin MARKARIAN, Lancaster (GB)

(21) Appl. No.: 14/677,269

(22) Filed: Apr. 2, 2015

Related U.S. Application Data
(63) Continuation of application No. PCT/GB2013/052635, filed on Oct. 9, 2013.

(30) Foreign Application Priority Data
Oct. 10, 2012 (GB) 1218209.3

(51) Int. Cl. G06N 99/00; G06N 7/00

(52) U.S. Cl. CPC G06N 99/005; G06N 7/005

(57) ABSTRACT

A method and apparatus for classifying the state of a system are described. The state of the system can be in one of a plurality of different classes and the system can have at least one property represented by a set of data items. A current data item representing a property of the system is received. The system is classified as being in one of a plurality of different classes based on the probability that the system is in any one of the plurality of classes calculated using the current data item, a recursively calculated mean value for the set of data items representing the property of the system and at least one recursively calculated statistical parameter for the set of data items representing the property. It is determined whether to output a signal based on the class in which the system is classified.

This application is a Continuation of International Application No. PCT/GB2013/052635, filed on Oct. 9, 2013, the contents of which are incorporated herein by reference in their entirety.

The present invention relates to classifying the state of a system and in particular to methods, apparatus and computer program products for classifying the state of a system.

Classification lies in the field of machine learning. In particular, statistical classification is the problem of identifying a sub-group to which a new data item belongs, where the identity or label of the sub-group is unknown, on the basis of a training set of data containing data items whose sub-group association is known. Such classifications will show a variable behaviour which can be investigated using statistics. New individual items of data need to be placed into groups based on quantitative information on one or more measurements, traits or characteristics, etc. of the data and based on the training set for which previously decided groupings or classes have already been established.

A wide variety of different classifiers are known and some of the most widely used classifier algorithms include neural network, support vector machines, k-nearest neighbours, Gaussian mixture model, Gaussian, naïve Bayes and decision tree classifiers.

However, a significant issue, particularly for complex systems, is the computational burden imposed by the classification algorithm. This may require very significant computing resources to be made available in order to implement the algorithm both for speed and accuracy of classification reasons. Further, for some systems, real-time classification may be needed, in order to provide a control and/or data signal to be timely issued. Reliable real-time classification may not be possible for some classification algorithms irrespective of the computing resources available or with the computing resources practically available in a real world or industrial environment.

Hence, there is a need for a reliable classification method which has a low computational overhead.

A first aspect of the invention provides a method for classifying a system and in particular the state of a system. The state of the system can be in one of a plurality of different classes. The system can have at least one property represented by a set of data items. A current data item representing a property of the system can be received. The system can be classified as being in one of a plurality of different classes based on the probability that the system is in any one of the plurality of classes. The probability can be calculated using the current data item, a recursively calculated mean value for the set of data items representing the property of the system and at least one or a plurality of recursively calculated statistical parameter for the set of data items representing the property. Whether to output a signal can be determined based on the class in which the system is classified.

The method uses recursive calculations and so the computational burden is low. Hence, the method can operate in real-time, even for complicated systems having tens, hundreds or even thousands of different properties that can be represented by a set of data, for example data output by sensor or the like. The recursive calculations use only a current data item and stored data items which summarise, in a statistical way, the past operation of the system. Hence, the method does not need to process all, or large number of, past or historical data items.

The input to the system can be a set data items having numerical values, and in some cases a sequence of numerical values, representing one or more physical entities. In many cases the data items can come from, or have been generated by, physical sensors, but not necessarily. For example the data items might represent the number of sales of a specific product in a given time interval by a supermarket in which case the data set might be the result of a query to a database and only indirectly arise from a physical sensor (in this example a supermarket checkout barcode scanner).

The data items are not necessarily a time series. The benefits of the invention also arise for off-line unordered data. However, the invention is particularly applicable to real-time applications where other approaches are not suitable because of their relative computational inefficiency.

The system can include one or a plurality of sensors or transducers. Each sensor or transducer can output data representing a different property of the system. Each sensor or transducer can output a single set of data or a plurality of sets of data.

The data processed using the method can be applied to on-line data or off-line data. On-line data might include time series data being received in real time. Off-line data might include batch data. The batch data might include time series data but which has been collected over a time period.

The method can be a real-time classification method.

The method can further comprise recursively calculating and/or storing an updated mean value for the data item representing the property of the system using the current data item. The method can further comprise recursively calculating and/or storing a plurality of updated statistical parameters for the set of data items representing the property.

The method can further comprise receiving an input of an actual class of the system for the current data item. This can be used to train the classifier.

The method can further comprise setting the actual class of the system to the input actual class, or else to the class that the system was classified as being in.

The method can further comprise maintaining a data structure which stores, for each of the plurality of classes, data items representing the recursively calculated mean, the recursively calculated statistical parameters and the associated class of the system. The data structure can comprise a single entity or a plurality of entities. The data structure can be in the form of a single table having a separate row for each different class. The data structure can be in the form of a plurality of tables each corresponding to a different class.

The method can further comprise creating a new data structure storing data items representing the recursively calculated mean, the recursively calculated statistical parameters and the associated class of the system when it is determined that the system is in a class which does not correspond to any previous class.

The recursive calculating and storing can be only carried out if either an actual class has been input or no actual class has been input and there is a low classification error associated with the class in which the system has been classified. This can help to improve the reliability of the classifier.

Each recursive calculation can use a previously stored value representing all of the previously received data items. Hence, as only a current data item value and a summary of all previously received data items are used, the complexity of calculation, and memory required for storing data, are both very low.

The values used in the recursive calculations representing previously received data items can be stored in a data structure. The values can be stored associated with a class in which the system has been classified. The data structure can be in the form of a table. A class data item representing the class in which the system has been classified can be stored in the data structure. The class data item can be stored in a same row of a table as the values used in the recursive calculations representing previously received data items. The class data item can be a class label data item.

The statistical parameters can include one or more of the covariance matrix, the inverse of the covariance matrix and the determinant of the covariance matrix. The statistical parameters can be determined for each different class of the data.

A value representing the normalised outer product of all previously received data items and/or the mean of the current data items can be used to calculate the statistical parameters.

The system can have a plurality of properties. The method can be applied for the plurality of properties. Each property of the system can be represented by a set of data items. A current data item representing each property of the system can be received. The probability can be calculated using the current data items, a recursively calculated mean value for the set of data items representing the properties of the system and at least one or a plurality of recursively calculated statistical parameter for the set of data items representing the properties. A mean value for each data item can be recursively calculated and updated using the current data items. A plurality of statistical parameters for the data items representing each of the properties can be recursively calculated and updated.

The system can include one or more sensors for outputting data representing one or more properties of the system. The data can be time series data.

The method can include outputting a variety of different kinds of signal. The signal can encode or correspond to a control, command and/or data. The signal can be selected from: a data signal; a control signal; a feedback signal; an alarm signal; a command signal; a warning signal; an alert signal; a servo signal; a trigger signal; a data capture signal; and a data acquisition signal.

The method can include recursively calculating a covariance matrix. The method can include occasionally regularising the covariance matrix to avoid singularity of the covariance matrix. The covariance matrix can be regularised each time a pre-defined number of data items have been received.

The system can be any electrical or electro-mechanical system. The system can be a machine, an apparatus, a vehicle, an engine, a plant, a piece of plant, a piece of machinery, an electrical or electronic device or similar.

The system can be a video system. The sensor can be an image sensor. The data can be image data. The property can relate to a sub-region of a frame of image data. The method can further comprise processing the image data to extract one or more image features. The image data can be video data or still data.

A second aspect of the invention describes a data processing apparatus for classifying the state of a system. The data processing apparatus can comprise a data processing device and a storage device in communication with the data processing device. The storage device can store computer program code executable by the data processing device to carry out the method aspect of the invention and any preferred features thereof.

A third aspect of the invention provides a system. The system can comprise at least one operative part and at least one sensor which can output data representing a property of the system or of the operative part. The data can be time series data. The system can also include a data processing apparatus according to the second aspect of the invention. The data processing apparatus can be in communication with the sensor to receive the data from the sensor.

The system can include a plurality of sensors. Each sensor can output data representing a different property of the system or a part of the system. The data can be time series data.

The data processing apparatus can have an output. The output can be in communication with the system to output the signal to the system. Additionally or alternatively, the output can be in communication with another system or a sub-part or sub-system of the system. The data processing apparatus can have a plurality of outputs. Each output can be in communication with a different part of the system, a different system or other apparatus or devices.

The system can be an imaging system. The operative part can comprise an image sensor. The image sensor can output video image data or still image data.

A fourth aspect of the invention provides a computer readable medium storing computer program code executable by a data processing device to carry out the method aspect of the invention and any preferred features thereof.

Embodiments of the invention will now be described in detail, by way of example only, and with reference to the accompanying drawings, in which:

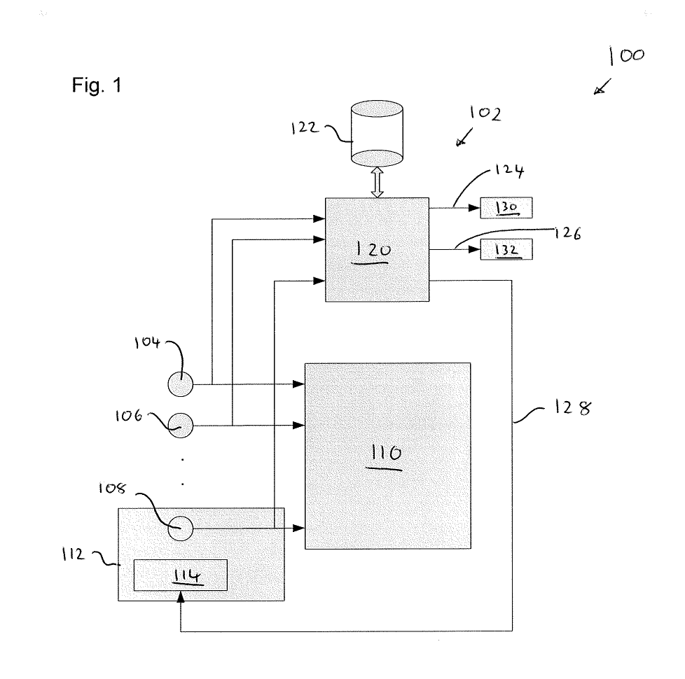

FIG. 1 shows a schematic block diagram of an aircraft system according to the invention and including a data processing apparatus according to a first embodiment of the invention;

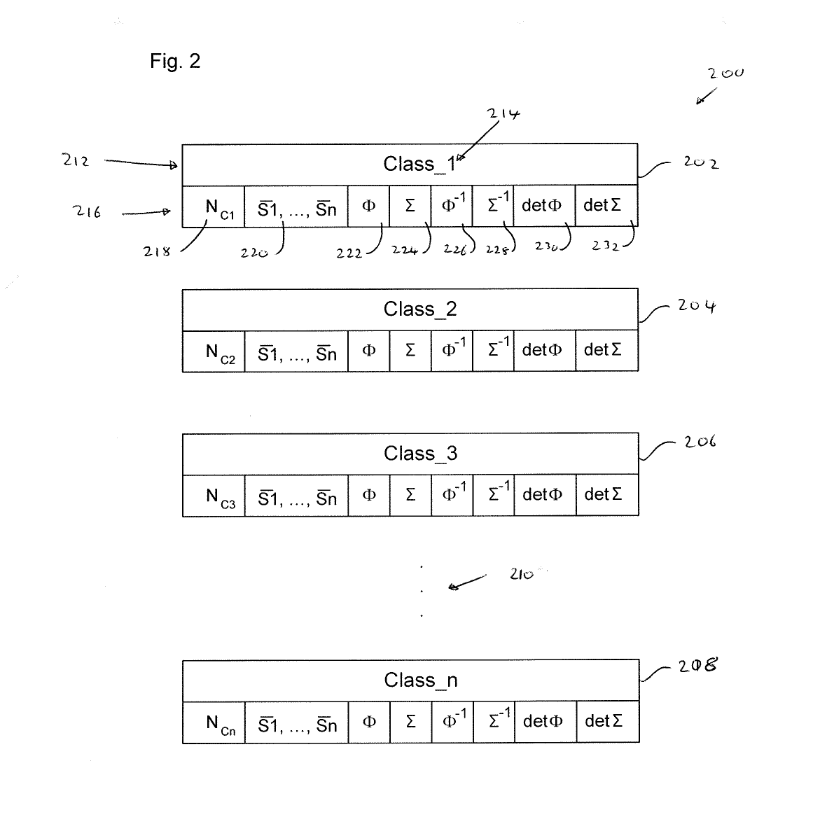

FIG. 2 shows a graphical representation of data structures used in a first embodiment of the invention;

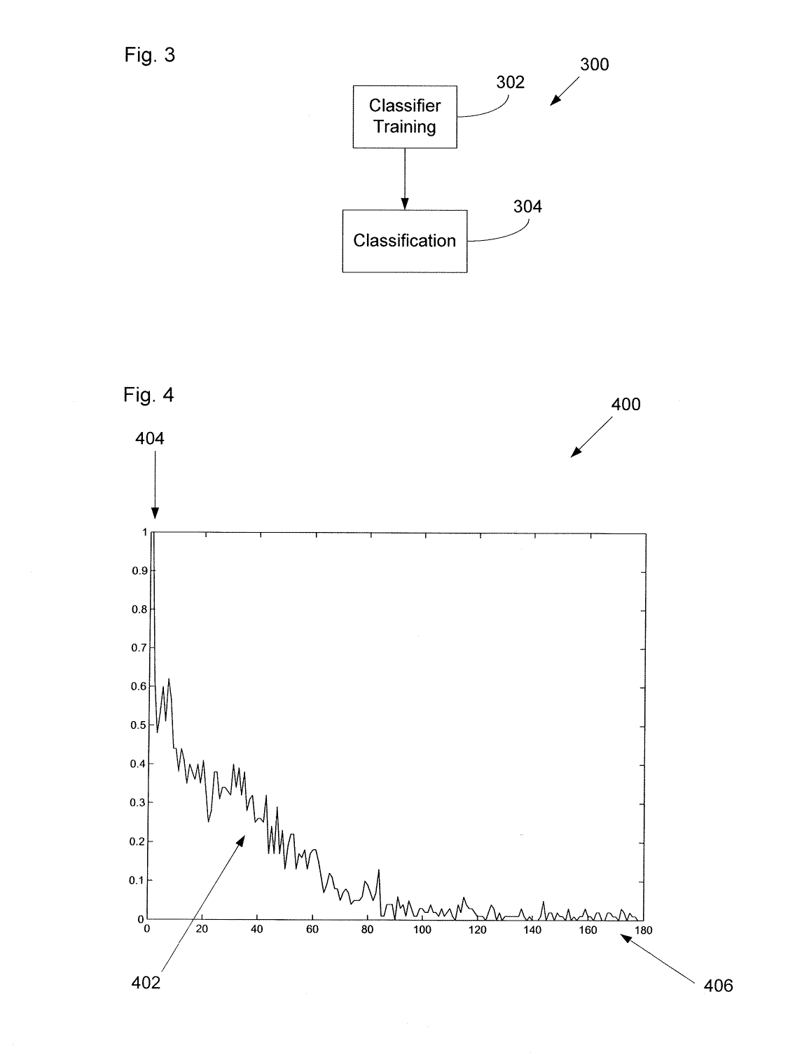

FIG. 3 shows a flow chart illustrating training and classification phases of the invention;

FIG. 4 shows a graphical representation of the proportion of classification errors as a function of data samples illustrating the progression from the training phase to the classification phase of operation;

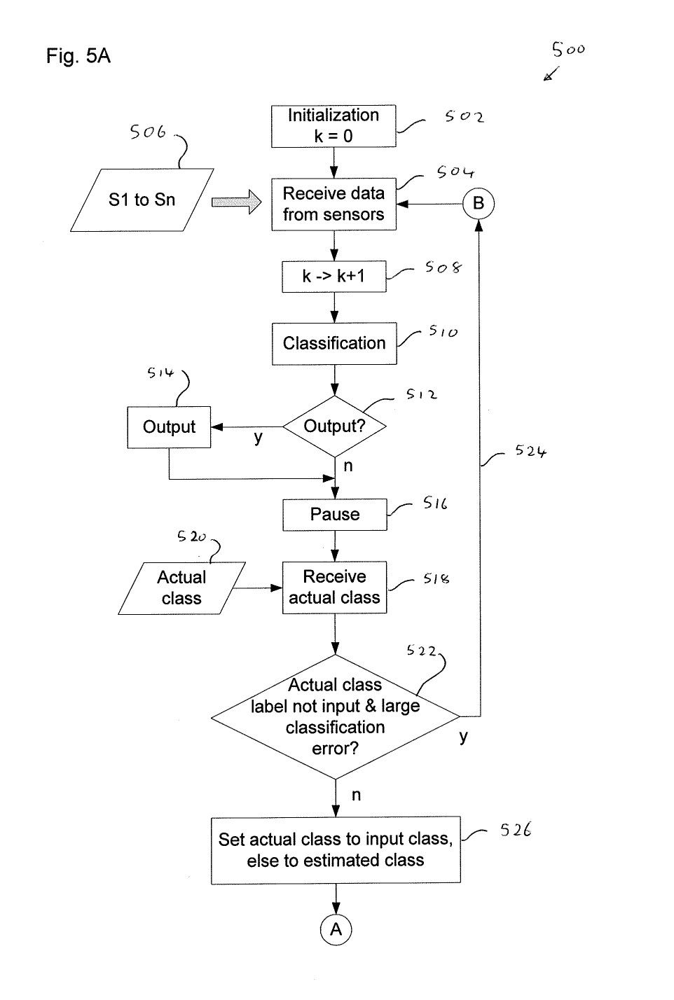

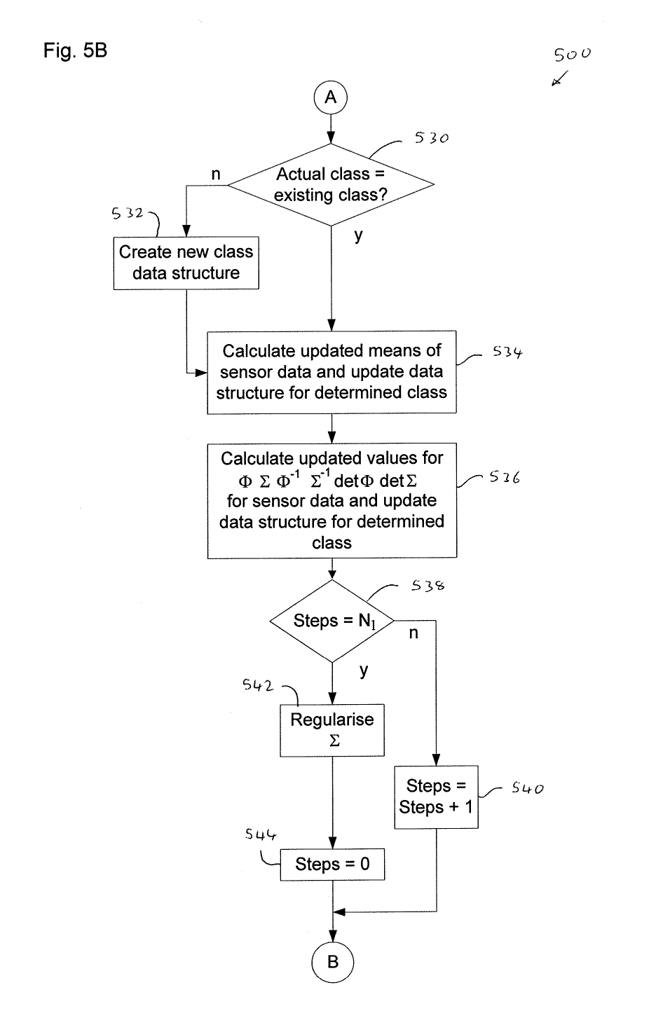

FIGS. 5A and 5B show a flow chart illustrating a data processing method of the invention;

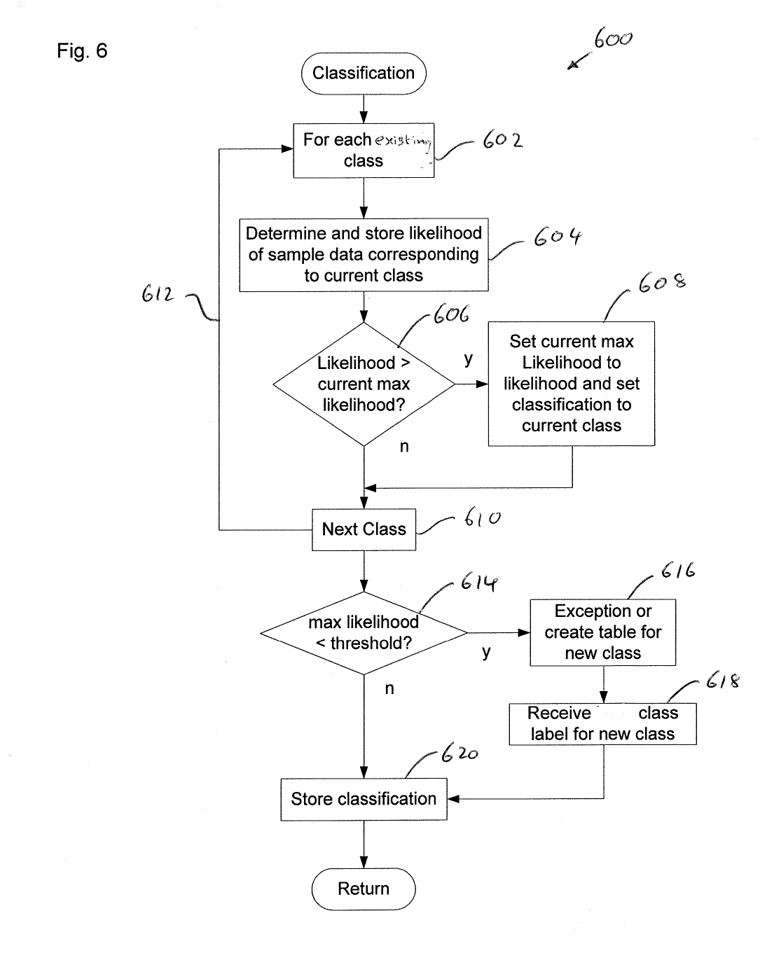

FIG. 6 shows a process flow chart illustrating a classification step of the method illustrated in FIGS. 5A and 5B in greater detail;

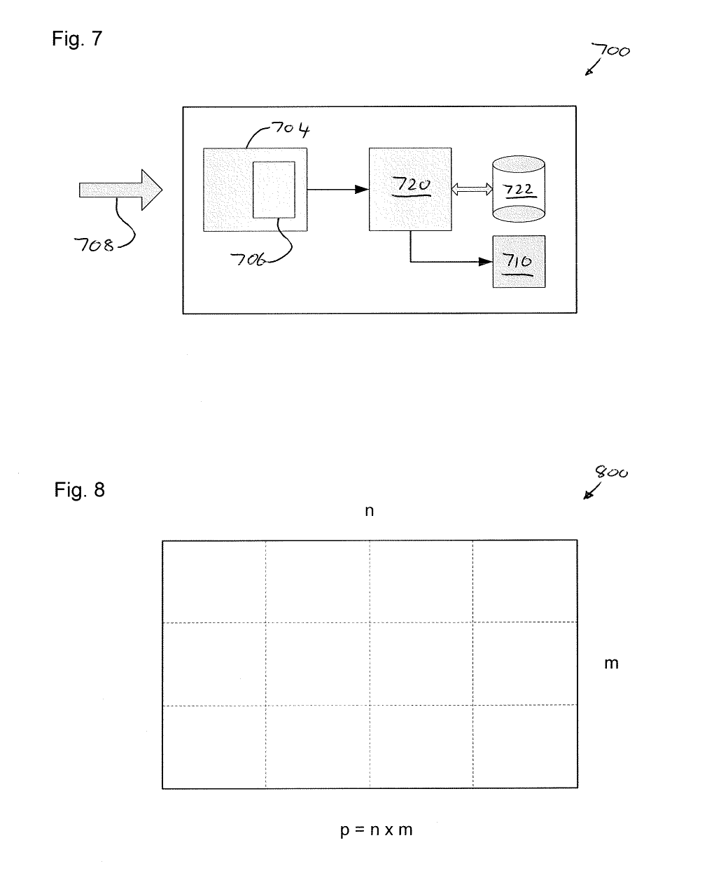

FIG. 7 shows a schematic block diagram of an imaging system according to the invention and including a data processing apparatus according to a second embodiment of the invention;

FIG. 8 shows a graphical representation of a frame of image data being composed of a plurality of video data bins;

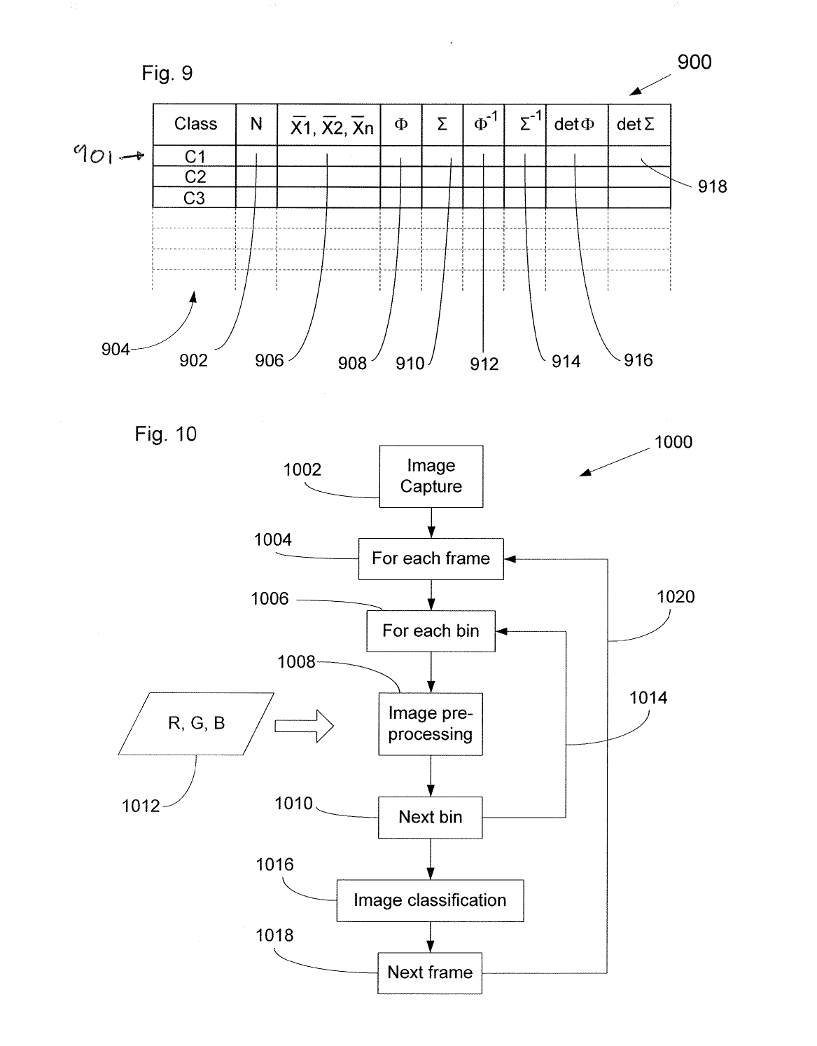

FIG. 9 shows a graphical representation of a data structure used in a second embodiment of the invention;

FIG. 10 shows a flow chart illustrating an image data processing method using a second embodiment of the invention; and

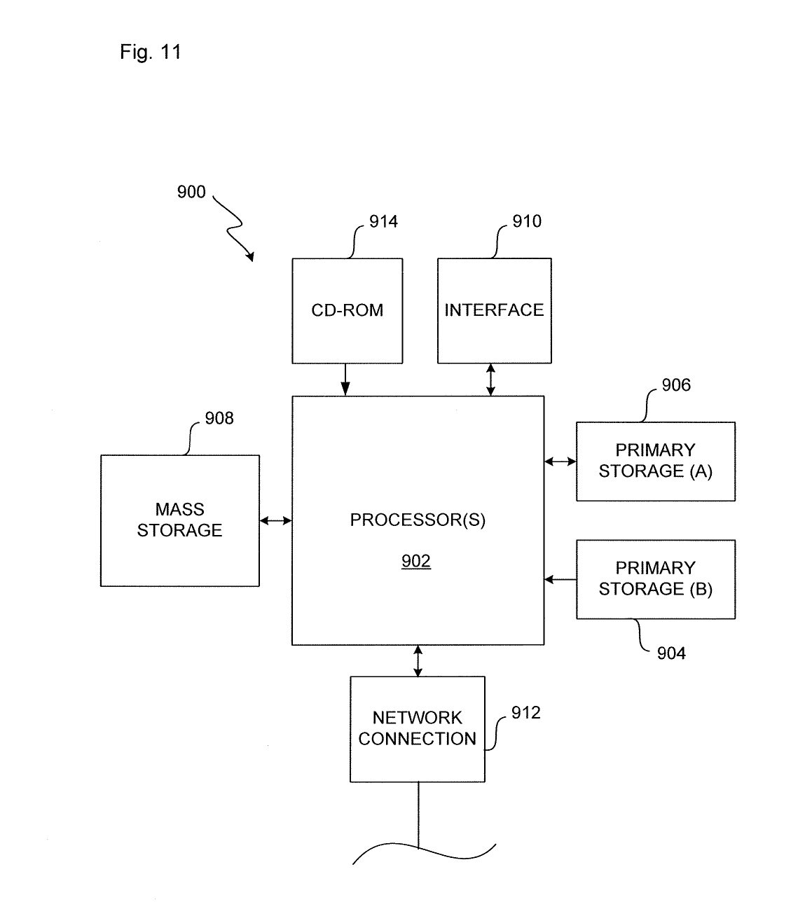

FIG. 11 shows a block diagram of a data processing device suitable for implementing the first or second embodiment of the invention.

Similar items in different Figures share common reference signs unless indicated otherwise

Generally, the invention provides an adaptive way of classifying the behaviour of complex systems, which can be carried out in real-time. In the context of certain systems, the system behaviour may be classified as a fault, whereas in other systems, a specific classification of the overall system may be a trigger for a control signal, a feedback signal, data recording or some other action. Importantly, no a priori knowledge of the system is required. The invention may be configured with a suitable temporal sampling interval for capturing data from the system (for example, a few or a few tens of samples per second), or may determine a suitable sampling interval itself. In particular, the invention has no need for knowledge of ranges of sensor data, operating limits for sensor data or the meaning of sensor data.

A period of learning is allowed (either in real-time, or by being fed captured historical data), and a model of various “normal” behaviours of the system can be built up. This behaviour may include multiple classes of normal operating modes, and the invention can automatically discover these modes. For example, the sensor data from an aircraft will take different normal values depending on the phase of the flight, such as take-off, cruising and landing. A signal, such as an alarm, control signal or trigger signal, can be output when data is received resulting in the current state of the system being sufficiently statistically outside a normal learned mode, i.e. classified as being in a non-normal or anomalous mode.

Before describing example embodiments of the invention in detail, the mathematical basis of the classifier of the invention will be described. The classifier is optimal and non-linear (quadratic). The approach assumes a Gaussian distribution for the probability of the data describing the system state and that distances between new data items and mean values, which serve as prototypes, are of Mahalonobis type. An exact formula is introduced for the recursive calculation of an inverse covariance matrix as well as for the determinant of the covariance matrix which are both used to allow recursive calculation, using current data items, historical mean values and the covariance matrix, of the maximum likelihood criteria which guarantees that the classifier is optimal. This makes it possible to recalculate, after each new data sample, the exact value of the criteria without having to store all past data.

The approach is also useful for other types of data distribution, but the results will not be optimal as they are in the case of a Gaussian distribution.

An optimal Bayesian type classifier with quadratic Fisher discriminant criteria will now be described. Further details of Bayesian classifiers in general are provided in C. Bishop, Pattern Recognition and Machine Learning, Springer, N.Y., USA, 2nd edition, 2009, the content of which is incorporated herein by reference in its entirety for all purposes.

Consider the problem of classifying data samples from an n-dimensional space of features represented by real numbers, xεRⁿ, into a finite set of non-overlapping classes C={1, . . . , c}. It is assumed that the data in each class (say c*) have the same type of distribution which can be parameterised by its mean, μ_{c*} and covariance Σ_{c*}. The probability density function (pdf) of a data sample x to be of class c* is denoted:

p(x|c*)=N(μ_{c*},Σ_{c*}) (1)

where the * superscript denotes a certain selected c out of all of the classes, 1 to c. Then the optimal (i.e. optimal in terms of maximum likelihood) Bayesian classifier with quadratic Fisher discriminant criteria is provided by:

arg max_{c*εC})[ln(p_{c*}λ_{c*})−1/2(x−μ_{c*}Σ_{c*}⁻¹(x−μ_{c*})^{T}−1/2ln(det(Σ_{c*}⁻¹))] (2)

where p_{c*} is the a priori probability that the data sample is of class c*, λ_{c*} is the penalty for misclassifying the data sample to class c*, μ_{c*} is the expectation of the class c* (i.e. the mean value) and Σ_{c*} is the covariance of the class c*. The expression within is evaluated for each class of the classifier and involves matrix operations. As indicated above, x is an n-dimensional vector for a current data sample in an n-dimensional space of features.

For practical applications a finite set, or stream, of data samples can be considered, in which the data set or stream is composed of n-dimensional real numbers and C={c₁, . . . , c_{C}} provides a set of C class labels.

Then the maximum likelihood solution is

$$class ( x ) = {argmax}_{c} ( p ( C \vert x ) ) ; {p}_{j} = \frac{{N}_{j}}{k} \qquad ( 3 )$$

where N₁ is the number of data samples of class j,

$${μ}_{j} = \frac{1}{{N}_{j}} {\sum }_{i = 1}^{k} {x}_{l} I [ {c}_{l} = j ] \qquad ( 4 )$$

is the mean and

$${Σ}_{j} = \frac{1}{{N}_{j}} {\sum }_{i = 1}^{k} {x}_{i} {x}_{i}^{T} I [ {c}_{i} = j ] - {μ}_{j} {μ}_{j}^{T} \qquad ( 5 )$$

is the covariance matrix.

A recursive solution is adopted. In a real-time (also referred to herein as “on-line”) implementation, the data samples are arriving one by one. An issue with real-time, or on-line, classification is how to automatically update the classifier. Re-designing the classifier (i.e. solving equations (2) to (5)) for each new data sample is not efficient. Moreover, inverting the matrix of the covariance is prone to problems such as singularities. Further, calculating the determinant of the covariance matrix is also computationally very expensive.

While updating the mean (4) and covariance (5) are not very computationally expensive (having quadratic computational complexity O(n²)), the inverse and determinant of the covariance matrices is of an order of magnitude more computationally expensive (i.e. cubic O(n³)). An exact derivation of both the inverse covariance matrix and the determinant of the covariance matrices is described in what follows.

An exact derivation of a recursive form of the inverse covariance matrix will now be described. From analysing the classifier defined by equations (2)-(5), the following quantities need to be known and updated in real-time for every new data sample available: μ, Σ, Σ⁻¹, det(Σ). The determinants are related such that det(Σ⁻¹)=1/det(Σ).

The following formula is used in the derivation, and which is known as the matrix inverse lemma:

$${( M + {xx}^{T} )}^{- 1} = {M}^{- 1} - \frac{( {M}^{- 1} x ) ( {x}^{T} {M}^{- 1} )}{1 + {x}^{T} {M}^{- 1} x} \qquad ( 6 )$$

Starting from the expression for the covariance matrix:

$$Σ = \frac{1}{k} {\sum }_{i = 1}^{k} ( {x}_{i} - {μ}_{k} ) ( {x}_{i} - {μ}_{k} ) = \frac{1}{k} {\sum }_{i = 1}^{k} {x}_{i} {x}_{i}^{T} - {μ}_{k} {μ}_{k}^{T} \qquad ( 7 )$$

the means, μ, can easily be updated recursively. The first element in the expression (7) is denoted by:

$${Φ}_{k} = \frac{1}{k} {\sum }_{i = 1}^{k} {x}_{i} {x}_{i}^{T} \qquad ( 8 )$$

which is a normalised outer product of all data items with themselves up to a time corresponding to that of the kth data item.
For k+1:

$${Φ}_{k + 1} = \frac{k}{k + 1} {Φ}_{k} + \frac{1}{k + 1} {x}_{k + 1} {x}_{k + 1} \qquad ( 9 )$$

Using equation (6) the recursive update of the inverse of the quantity, Φ, is given by:

$${Φ}_{k + 1}^{- 1} = \frac{k + 1}{k} {Φ}_{k}^{- 1} - \frac{( {Φ}_{k}^{1} {x}_{k + 1} ) ( {x}_{k + 1}^{T} {Φ}_{k}^{1} )}{k + 1 + {x}_{k + 1}^{T} {Φ}_{k}^{- 1} {x}_{k + 1}} \qquad ( 10 )$$

Returning to equation (7), which is the expression for the covariance matrix, at time step k+1:

Σₖ₊₁=φₖ₊₁−μₖ₊₁μₖ₊₁^{T}=Φₖ₊₁(tμₜ₊₁)(tμₖ₊₁^{T}) (11)

where i=√−1. The inverse of the covariance is then (using equation (6))

$$\begin{matrix}{\sum }_{k + 1}^{- 1} = {Φ}_{k + 1}^{- 1} - \frac{( {Φ}_{k + 1}^{- 1} {iμ}_{k + 1} ) ( {iμ}_{k + 1}^{T} {Φ}_{k + 1}^{- 1} )}{1 + {iμ}_{k + 1}^{T} {Φ}_{k + 1}^{- 1} {iμ}_{k + 1}} = \\ = {Φ}_{k + 1}^{- 1} + \frac{( {Φ}_{k + 1}^{- 1} {μ}_{k + 1} ) ( {μ}_{k + 1}^{T} {Φ}_{k + 1}^{- 1} )}{1 - {μ}_{k + 1}^{T} {Φ}_{k + 1}^{- 1} {μ}_{k + 1}}\end{matrix} \qquad ( 12 )$$

Starting with an initial estimate for the covariance matrix, Σ₀, the starting conditions in the covariance estimate are defined as

φₑ=αI, μ₀=0 (13)

where α is a small constant. In this way, the covariance matrix will be non-singular from the very beginning. Finally, the expressions required for the update of the covariance and inverse covariance matrix are provided by:

$$\begin{matrix}{Φ}_{k + 1} = \frac{k}{k + 1} {Φ}_{k} + \frac{1}{k + 1} {x}_{k + 1} {x}_{k + 1} & ( 14 ) \\ {Φ}_{k + 1}^{- 1} = \frac{k + 1}{k} ( {Φ}_{k}^{- 1} - \frac{( {Φ}_{k}^{- 1} {x}_{k + 1} ) ( {x}_{k + 1}^{T} {Φ}_{k}^{- 1} )}{k + {x}_{k + 1}^{T} {Φ}_{k}^{- 1} {x}_{k + 1}} ) & ( 15 ) \\ {μ}_{k + 1} = \frac{k}{k + 1} {μ}_{k} + \frac{1}{k + 1} {x}_{k + 1} & ( 16 ) \\ {\sum }_{k + 1} = {Φ}_{k + 1} - {μ}_{k + 1} {μ}_{k + 1}^{T} & ( 17 ) \\ {\sum }_{k + 1}^{- 1} = {Φ}_{k + 1}^{- 1} + \frac{( {Φ}_{k + 1}^{- 1} {μ}_{k + 1} ) ( {μ}_{k + 1}^{T} {Φ}_{k + 1}^{- 1} )}{1 - {μ}_{k + 1}^{T} {Φ}_{k + 1}^{- 1} {μ}_{k + 1}} & ( 18 )\end{matrix}$$

Using equations (13), (14), (16) and (17) arrives at the following expression:

$${\sum }_{k} = \frac{1}{k} {\sum }_{i = 1}^{k} {x}_{i} {x}_{i}^{T} - {μ}_{k} {μ}_{k}^{T} + \frac{α}{k} l \qquad ( 19 )$$

In practice, the last regularisation component term of equation (19) can tend towards zero which can lead to computational problems. Theoretically, that corresponds to tending to the true covariance matrix, but in practice this can lead to singularity of the matrix and a computational algorithm may stop. This practical problem can be solved by setting a limit on the number of steps, N₁, after which the matrix is regularised again by

$$\frac{α}{{N}_{1}} I .$$

This gives the following expression for the covariance matrix:

$${\sum }_{k} := ( {\sum }_{k} + \frac{( {N}_{1} - 1 )}{{N}_{1}} α I ) \qquad ( 20 )$$

An exact derivation of a recursive form of the determinant of the covariance matrix will now be described. The aim is to calculate the determinant of the covariance matrix at the moment in time k+1, det(Σₖ₊₁). From equations (14) and (17):

$$det ( {\sum }_{k + 1} ) = det ( \frac{k}{k + 1} {Φ}_{k} + \frac{1}{k + 1} {x}_{k + 1}^{T} {x}_{k + 1} - {μ}_{k + 1}^{T} {μ}_{k + 1} ) \qquad ( 21 )$$

Starting with the first two components in the brackets:

$$det ( \frac{k}{k + 1} {Φ}_{k} + \frac{1}{k + 1} {x}_{k + 1}^{T} {x}_{k + 1} ) = det ( {φ}_{k} ) det ( \frac{k}{k + 1} I + \frac{1}{k + 1} {Φ}_{k}^{- 1} {x}_{k + 1}^{T} {x}_{k + 1} ) \qquad ( 22 )$$

The following proposition is adopted. The n eigen-values of a matrix A are denoted by λ₁, . . . , λₙ. Then the eigen-values of the matrix (A+αI) will be (λ₁, +α), . . . , (λₙ+α) and the eigenvectors remain the same. The determinant of the matrix

$$\frac{k}{k + 1} I + \frac{1}{k + 1} {Φ}_{k}^{- 1} {x}_{k + 1}^{T} {x}_{k + 1}$$

can be found as a product of eigen-values:

$$rank ( \frac{1}{k + 1} {Φ}_{k}^{- 1} {x}_{k + 1}^{T} {x}_{k + 1} ) = \{ \begin{matrix}0 , & {x}_{k + 1} = 0 \\ 1 , & {x}_{k + 1} \neq 0\end{matrix} \qquad ( 23 )$$

Thus not more than a single eigen-value in the respective matrices differs from zero. Therefore, it is possible to write:

$$\sum {λ}_{i} = \{ \begin{matrix}0 , & {λ}_{i} = 0 ∀ i = 1 , … , n \\ {λ}_{i} , & i : {λ}_{i} \neq 0\end{matrix} \qquad ( 24 )$$

Because the trace function tr(A) is invariant for any Hermit operator for any basis (from the theorem for the characteristic polynomial of the operator) it follows that:

$$tr ( \frac{1}{k + 1} {Φ}_{k}^{- 1} {x}_{k + 1}^{T} {x}_{k + 1} ) = \sum {λ}_{i} = \{ \begin{matrix}0 , & {λ}_{i} = 0 ∀ i = 1 , … , n \\ {λ}_{i} , & i : {λ}_{i} \neq 0\end{matrix} \qquad ( 25 )$$

### Denoting

$$h = \{ \begin{matrix}0 , & {λ}_{i} = 0 ∀ i = 1 , … , n \\ {λ}_{i} , & i : {λ}_{1} \neq 0\end{matrix}$$

then

$$h = \frac{〈 {Φ}_{K}^{- 1} {x}_{k + 1} , {x}_{k + 1} 〉}{k + 1} \qquad ( 26 )$$

### Therefore,

$$det ( \frac{k}{k + 1} I + \frac{1}{k + 1} {Φ}_{k}^{- 1} {x}_{k + 1}^{T} {x}_{k + 1} ) = {( \frac{k}{k + 1} )}^{n - 1} ( \frac{k}{k + 1} + h ) \qquad ( 27 )$$

In a similar way:

det(Φₖ₊₁−μₖ₊₁^{T}μₖ₊₁)=det(Φₖ₊₁)det(1−Φₖ₊₁⁻¹μₖ₊₁)=det(1−Φ(k+1)′(−1)μ₁(k+1)′Tμ₁(k+1)=1−<Φ₁(k+1)^{t}(−1)μ₁(k+1),μ₁(k+1)>)

Finally,

$$\begin{matrix}det ( {Φ}_{k + 1} ) = det ( {Φ}_{k} ) {( \frac{k}{k + 1} )}^{n - 1} ( \frac{k}{k + 1} + \frac{〈 {Φ}_{k}^{- 1} {x}_{k + 1} , {x}_{k + 1} 〉}{k + 1} ) & ( 28 ) \\ det ( {\sum }_{k + 1} ) = det ( {Φ}_{k + 1} ) ( 1 - 〈 {Φ}_{k + 1}^{- 1} {μ}_{k + 1} , {μ}_{k + 1} 〉 ) & ( 29 )\end{matrix}$$

Hence, a recursive approach can be used in the classifier algorithm. The recursive approach reduces the computational complexity of the algorithm to quadratic, i.e. O(n²). Updated values are calculated and applied to only the class to which the new data sample belongs. The principle of on-line, or real-time, classifiers is similar to the principle of adaptive control and estimation-update sequences used in signal processing and estimation theory. The low computational complexity and recursive updates enables a rapid update and real-time update of the optimal classifier defined by equation (2) using equations (16) to (18), (29) and the fact that the determinant of the inverse covariance matrix is equal to the inverse of the determinant of the covariance matrix for the recursive calculation of the mean, covariance, inverse covariance matrix and the determinant of the covariance matrix. However, in some embodiments the classification does not need to be carried out in an online or real time mode in order to take advantage of the ease of computational burden. However, owing to its use of recursive calculations, and resultant ease of computation, the method is particularly suitable for real-time classification applications.

The algorithm on which the invention is based uses exact formulas for the automatic real-time update of the Fischer discriminant criteria of equation (2), assuming a Gaussian type pdf and Mahalonobis type distance, which can have various applications. A significant advantage is that the pdf is exact, and not approximate, and that it is recursively calculated. As mentioned above, for non-Gaussian distributions, the results are not exact but can still be used to give useful classification results.

A first embodiment of the invention will now be described in the field of flight data analysis to which the algorithm can be successfully applied. However, it will be appreciated that the invention is not limited to flight data analysis. Rather, the invention has application in relation to all kinds of electronic, mechanical and electro-mechanical systems in which it is useful to be able to classify the behaviour of the system and provide some output signal or data responsive to the determined classification. For example, a second embodiment of the invention is described below applied to the field of image processing.

In many aircraft there is typically a flight data recorder (FDR) which may record between a dozen and 1400 parameters relating to the aircraft (for example, values of properties of the aircraft, such as physical variables which might include pitch, approach speed, altitude, gear speed, acceleration, rate of descent, etc.). For example, the FDR of an Airbus A330 records about 1400 parameters at a frequency 16 Hz (i.e. one set of readings every 16^{th} of a second), an Embraer 190 FDR records about 380 parameters, an ATR 42 FDR records about 60, and some Fokker aircraft FDRs record merely 13 different parameters. Conventionally, Flight Data Analysis (FDA) is routinely performed off-line or not in real-time (i.e. after the flight) and primarily only on flights which had some easily identifiable problems. However, using the classifier of the invention it is possible to have an automatic classification of the state of the flight into a ‘Normal’ or an ‘Abnormal’ class, in real-time and during the flight, meaning that an alarm and/or other signals can be generate during the flight so that an emergency, or un-scheduled, landing can be made. This can be fully automated or the pilot/air crew on board can simply be notified of the abnormal state of the flight.

FIG. 1 shows a schematic representation of an aircraft flight system 100 according to the invention and including a data processing apparatus 102 providing an automatic real-time emergency landing-related classifier according to the invention. The aircraft parameters (data representing physical properties of the aircraft) which may be taken into account, and which may affect the landing of the aircraft, include, but are not limited to: the aircraft's normal acceleration (measured in g); the aircraft's altitude (measured in ft); the aircraft's pitch angle (in degrees); the aircraft's power on approach (measured in % of max power, and which is airframe dependent); the aircraft's bank angle (degrees); whether the aircraft's landing gear are down (a Boolean Yes/No logical state); whether the aircraft should go around (a Boolean Yes/No logical state); and whether the aircrafts flaps have adopted a landing position late (a Boolean Yes/No state). As will be appreciated some of these aircraft related parameters can be measured by various sensors, whereas other parameters may be derived from other control systems within the aircraft which can report on the state or condition of various parts of the aircraft, such as the logical rather than the physical parameters described above.

Returning to FIG. 1, the system 100 is a part of an aeroplane and includes a plurality of sensors 104, 106, 108 each measuring a property of the aircraft. The sensors 104, 106, 108 output data which is communicated to a flight data recorder 110, also known colloquially as a “black box” data recorder. The third sensor 108 is provided as part of a sub-system 112 of the aircraft. The sub-system can include multiple components, such as a servo 114. For example, the sub-system 112 can be a part of the flight control sub-system of the aircraft and servo 114 can be operable to adjust the wing flaps of the aircraft. Although three sensors are illustrated in FIG. 1, it will be appreciated that a far greater number of sensors will be provided in practice. For example, a typical commercial aircraft may have anywhere in the region of two to three thousand different sensors.

The data processing apparatus 102 includes a data processing unit 120 including one or more central processing units, local memory and other hardware as typically found in a conventional electronic general purpose programmable computer. The data processing unit 120 is in communication with a data store 122 which may be in the form of a database. Data processing unit 120 has a plurality of outputs 124, 126, 128. A first output 124 is in communication with a further part of the system 100, such as a display unit 130 in the cockpit of the aircraft. The system 100 may include a further part 132, such as a further computing or data processing device to which an output signal can be supplied by the data processing unit 120. Finally, a third output 128 is in communication with sub-system 112, and in particular, allows a signal path to wing servo 114. Hence, the data processing unit 120 may output various different signals to different parts of the system in order to control or otherwise interact with other parts of the system 100.

Data processing unit 120 locally stores computer program code to implement a data processing method also according to an aspect of the invention and which will be described in greater detail below. For example, the computer program code may be stored in compiled form in a local ROM. A local RAM is also provided to provide working memory and storage for the data processing unit in order to execute the computer program instructions.

FIG. 2 illustrates an overall data structure 200, in the form of a plurality of tables or separate data structures 202, 204, 206, 208, each corresponding to a different class of the system and each storing various data items used by the data processing method illustrated in FIG. 3. As illustrated by dots 210, the number of tables can vary and the number of tables will typically increase during a training phase, as described below, in which the method learns the different classes of behaviour that the system can exhibit. Each data structure 202, 204, 206, 208 includes a field 212 which stores a data item 214 indicating which particular class, of the plurality of different classes, the data structure corresponds to. Each data structure also includes a row 216, including a plurality of fields for storing data items. A first field 218 stores a data item, N_{C1}, representing the number of times that a data sample has been classified in the corresponding class, Class_{—}1. A second field 220 is provided for storing values of the mean of different properties, denoted S1 to Sn, of the aircraft and which have been detected by the n sensors or other inputs to the system (e.g. logical inputs received from other parts of the aircraft system and not shown in FIG. 1). The means of the properties are calculated from the input data samples which have been classified to the particular class. The table also has fields for storing data items representing the recursively calculated values of Φ 222, the covariance matrix Σ 224, the inverse of Φ 226, the inverse of the covariance matrix Σ 228, the determinant of Φ 230, and the determinant of the covariance matrix Σ 232.

As can be seen from equation (8), Φ is effectively a normalised outer product of all data values ‘to date’ or put another way a normalised outer product of each data item with itself for all preceding or previously received data items. The recursive calculation of each of the values illustrated in FIG. 2 is described in greater detail above and below.

Field 218 can store a class label, as described below, which indicates which particular class of behaviour the data structure corresponds to, e.g. “normal”, “fault”, “unknown”. Initially field 218 can simply store a class identifier data item which allows the different classes to be differentiated, e.g. Class_{—}1, Class_{—}2, Class_{—}3, before any real world salience is attached to the different classes. Once real world class labels are established, then the class identifier can be replaced with the real world label. In other embodiments, the class label associated with each table is not provided as part of the table but is simply associated with its respective table by some other data structure, for example by using a mapping table or providing a reference or a pointer for each class label to the table with which it is associated. Hence, the class label is associated with a table, but need not be a part of the table.

The classification process and creation of the tables involves equation (2) and is described in greater detail below with particular reference to FIGS. 5 and 6

As mentioned above, and illustrated in FIG. 3, the classifier 102 undergoes a training phase 302 before it can reliably operate in a real-time classification phase 304. The classifier training phase 302 requires at some stage the input of real world labels so as to provide a link between the different classes that the method can identity and the classes of real world behaviour of the system that they correspond to. The training 302 can occur before use of the classifier in the classification phase 304, or can simply be an initial stage of the use of the classifier in which the early classification results are less reliable. The real-world data may have been collected from another, or other, aircraft or may be collected from the aircraft in which the classifier is installed. The two phases can follow one another for each new data item or each new flight (or phase) assuming that the true class label is eventually provided.

Generally, two different types of training can be used: off-line training, based on batch sets of training pairs of inputs or features and corresponding outputs or class labels or classification identifiers; and on-line training in which data samples come one by one and when there are k−1 pairs of inputs/features plus correct class labels/IDs the classifier is trained as described in equations (2), (16)-(18) and (29) above in order to predict the correct class label of the sample k. After that, if and when the correct class label of sample k is available the training can continue. These are the so called prior and posterior information pairs or predict and update used in automatic control and estimation theory. For the example of flight data, once a fault is confirmed by a human (for example the pilot or a ground controller) the class label can be set to ‘FAULT’ from ‘NORMAL’ and the input data or features can be used for re-training. Before that, off-line pre-training can be used. Future use of the same classifier works automatically and does not require re-training from the beginning but only based on the new labels. For the image processing embodiment described below, once a landmark is determined by a human user to be of a specific class, the labels can be used for re-training, but again not from the start but only based on the new data samples.

FIG. 4 shows a graphical representation 400 illustrating the transition from the training phase 302 (whether it be off-line or on-line) and the classification phase in which classification is more reliable. FIG. 4 shows a plot 402 of the proportion of incorrect classifications 402 against the number of data samples 406. As can be seen after 80 or so data samples, the proportion of incorrect classifications has reduced to around the 5% level and reduces further to around 1% or 2% after 100 data samples. For a single data sample, the error will be either 100% (i.e. wrong) or 0% (i.e. right) and on average 50%. However, the proportion quickly reduces as the number of data samples increases.

The process of classifier training 302 and classifier use 304 will now be described with reference to FIGS. 5A, 5B and 6. The training of the classifier and its use for classification can be considered different phases or stages of the same algorithm. However, the training stage requires the acquisition, at some stage, of real world class labels to be associated with each of the classes that the classifier establishes as part of its operation.

FIGS. 5A and 5B show a process flow chart illustrating a classification method 500 according to a first embodiment of the invention. The method begins at step 502 at which the process initializes and at least one table 202 is created and the fields set to initial values, corresponding to the k=0 step. For example, the number of data samples or sets classified to the table's class N_{C1} 218 is set to zero, the mean sensor values 220 are set to zero and Φ is set to αI (where I is the identity matrix) as indicated by equation (13).

Following initialization of the program, at step 504 a first data set or data sample of n data values 506 from the n sensors is received and at step 508 the data sample count index, k, is incremented by 1. As this is the first data sample (k=1) there is only a single class and so processing effectively skips to steps 534 and 536 at which the mean values for the sensor data S1 to Sn are calculated 534 and values for the various statistical parameters are calculated 532 and written to the corresponding fields of table 202. Processing continues (to be described in greater detail below) and returns to step 504 at which a second data sample 506 is received and the data sample index is incremented at step 508 (to k=2).

At step 510 a classification process is carried out using the most recently received data sample data items (i.e. for k=2) to determine which class the current data sample corresponds to. The classification step 510 is effectively a prediction or estimate of which class the system is believed to be in, at this stage of processing.

FIG. 6 shows a process flow chart illustrating a method 600 for determining the class corresponding to the most recently received or current data sample. In this example, there is currently only a single class and a second data sample (k=2) has been received. The method 600 effectively applies the classifier equation (2) to determine which class the current data sample has the highest likelihood of belonging to. At step 602, a loop is begun and each of the currently existing classes is selected in turn. At step 604, the expression in square brackets of equation (2) is evaluated using the current data sample and the relevant data items from the class table for the currently selected class in order to calculate the probability of the current data sample x, being a vector with values S1 to Sn, corresponding to the currently selected class.

At step 606 it is determined whether the likelihood for the current class is greater than a current maximum likelihood. During a first loop, the current maximum likelihood will be zero and so the current likelihood for the current class will be greater. And so at step 608, the current maximum likelihood is set to the current likelihood and the classification is set at the current class, in this case Class 1. Processing then proceeds to step 610 and a next class, if there are any remaining, is selected for evaluation and processing returns 612. Hence steps 602 to 612 implement a loop by which the method determines which of the currently existing classes there is the highest likelihood that the current data sample corresponds to.

As there is only a single class at present, processing proceeds to step 614 at which the maximum likelihood determined during loop 602-612 is compared to a threshold likelihood value, for example e⁻¹ which is approximately 0.38 and which represents the so called ‘one sigma’ condition. If the maximum likelihood for the current data sample is extremely low, then this may indicate that is an error in the data or some other problem (for example a sensor malfunctioning or noise) in which case at step 616 an exception or error handling routine may be called for example to discard the current data sample. Alternatively, if the maximum likelihood is merely very low, then this may indicate that the current data sample corresponds to a genuine class of behaviour of the system, but which is different to the behaviour corresponding to the currently existing class tables, in the current example, a class of behaviour different to that corresponding to the first class table 202. Hence, at step 616 a new class table 204 is created corresponding to the second class of behaviour. At step 618 a class label is assigned to the new class table. The class label can be an input, either from a user or another computer or system, and which provides a real world class label to be associated with the new class table. However, the real world class label does not need to be received at this stage and can be received subsequently or at some other time. Hence, if no real world class label is assigned at step 618, then the method automatically assigns a class label by incrementing a count of the number of different classes and assigning the class table that label, e.g. class_{—}2 in the current example.

The system may then store an indication that the current data sample (k=2) corresponds to the system being in class_{—}2 at step 620. Alternatively, if a new class table was not set up, then at step 614, processing may proceed directly to step 620 which the system stores an indication that the current data sample corresponds to the system being in class_{—}1. Hence, method 600 assigns an initial or estimated classification either from amongst the plurality of already existing classes, or a newly added class, to the most recent data sample. Processing then returns to method 500.

Hence, the current state of operation of the aircraft has been provisionally classified as being in one of a plurality of classes. Depending on the classification of the state of operation of the aircraft, and possibly secondary considerations, some output may or may not be required. Hence, at step 512, it is determined whether any output is required from the classifier. For example, if the aircraft is classified as being in a fault state, then at step 512, it may be determined that one or more output signals are required, such as an alarm signal, and at step 514, an alarm signal may be issued to the pilots' instrumentation 130 for display. The output determining step 512, may also take other input as well as simply the estimated classification of the state of operation of the aircraft. For example, logical input may also be taken from other systems or sub-systems of the aircraft and applied in a rule based approach to determine what output, if any, may be required at step 514. If it is determined at step 512 that no output is required, for example because the aircraft is classified as being in a normal state of operation, then output step 514 is by passed and processing proceeds to step 516.

At step 516, the method 500 can pause or wait. The extent of the delay can vary depending on the field of application of the method. For example, when the method is being applied to quickly varying input data sets then the delay can be a few seconds, tenths or hundredths of a second. In other applications the delay can be a few minutes or hours. Hence, delay 514 is simply a suitable delay to provide time for any real world feedback as to the actual class that the current data sample (k=2) belongs to. This is likely to be provided during the training phase, but may not be needed after the training phase. Hence, at step 518 there may optionally be some input of data 520 identifying the actual class that the current data sample corresponds to. The input may be from a user or may be from some other computer, system or apparatus. For example, if the current data sample corresponds to a normal mode of flight, then the actual class input at 518 may be that corresponding to ‘normal’, e.g. class_{—}1. Alternatively, if the current data sample corresponds to an abnormal mode of flight, then the actual class input may be that corresponding to ‘abnormal’ e.g. class_{—}2. It will be appreciated that the input may be either a class indicator (e.g. class_{—}1 or class_{—}2) or may be the real world class label (“normal” or “abnormal”). At some stage during the training phase a real world label will need to be input in order to attach real world significance to each of the classes created by the method.

Steps 518 and 520 are optional in the sense that they do not have to be completed for every data sample received. However, the more often they are completed, particularly during the early stage of the classifier, then the more rapidly the method will be able to train and/or improve its reliability of classification.

The method 500 can optionally include step 522 which can further improve the reliability of the classifier. At step 522 it is determined whether any actual class was input at step 522 and also whether there is a sufficiently large classification error associated with the estimated class. If no actual class was input and there is a large classification error associated with the estimated class generated by step 510, then processing returns to step 504 and the class tables are not updated. The classification error can be quantified by maintaining a count of the number of times the estimated class does not correspond to the input actual class (i.e. the number of wrong classifications) and also maintaining a count of the number of times that the system has been classified as being in the actual class (the total number of classifications). The classification error is the given by the number of wrong classifications divided by the total number of classifications. If that classification error exceeds some threshold, e.g. 5%, then the classification error can be considered large and processing can return to step 504.

Hence, if there is no actual class input and there is a large classification error associated with the estimated class, then it is preferable not to update the class table for the estimated class as there is no actual class available to confirm that the estimated class is correct and so the new data sample may make the classification method less reliable if the class table is updated using the current data sample. The large classification error may be an indication that the system is still effectively training for this class and so more actual class data may be needed.

If there is no actual class input and there is a low classification error associated with the estimated class, then this may indicated that the classification behaviour is reliable and even though there is no actual class it is acceptable to update the class table for the estimated class.

If there is an actual class input, then the classification error is irrelevant, and so the class tables can be updated using the actual class to help train the classifier.

After the determination at step 522, processing can proceed to step 526. If there was an input indicating the actual class at step 518 then the actual class is set as the input class, otherwise, in the absence of an input class, the estimated class is assumed to be accurate and the actual class is set to the estimated class at step 526.

At step 530, the method determines whether the actual class corresponds to any of the currently existing classes (e.g. class_{—}1 or class_{—}2). This determination can be carried out simply by comparing class labels. The class label for the actual class is compared with the class labels for all currently existing classes to see if a class corresponding to the actual class already exists or not. If not, the processing proceeds to step 532 and a new data structure 206 for a new class (class_{—}3) is created at step 532. Otherwise, if the actual class is determined to correspond to one of the existing classes at step 530, then at step 534, the mean values for the sensor inputs S1 to Sn are re-calculated (using the stored mean values and the current data sample values and equation (16)) and overwritten in field 220 for the table corresponding to the determined class. As indicated above if an actual class data item 520 is not received at step 518, then the preliminary classification determined by step 510 is assumed to be correct. If an actual class data item is received at step 518, then that classification is assumed to be correct (and may or may not correspond to the preliminary classification generated by step 510). Then at step 526, updated values for the statistical parameters are recursively calculated and the values updated in the table corresponding to the determined class by overwriting fields 222 to 232 respectively. Also, the data item indicating the number of data samples allocated to the classification, e.g. NC1 218, is incremented.

In particular at step 526, an updated value for 1 is recursively calculated using equation (14), an updated value of the covariance matrix is recursively calculated using equation (19), the inverse of 1 is recursively calculated using equation (15), the inverse of the covariance matrix is recursively calculated using equation (18), the determinant of 1 is recursively calculated using equation (28) and the determinant of the covariance matrix is recursively calculated using equation (29).

As described above, in order to avoid singularities in the covariance matrix, the covariance matrix may require regularisation. Hence, at step 538, it is determined whether the algorithm has been applied for a fixed number of steps, equal to a limit, N1. If the algorithm has not been applied N1 times, then processing proceeds to step 540 at which the number of times the algorithm has been applied (steps) is incremented by one. Otherwise, if the algorithm has been applied N1 times, then at step 542, the covariance matrix is regularised, corresponding to the application equation (20). The count (steps) of the number of time the method 500 has been applied is then reset to zero at step 544. Processing then returns to step 504 at which a next set of sensor data items is input, corresponding to k=3. Processing then continues to loop as described above.

Having described a first embodiment of the invention, in relation to an aircraft operation system, a second embodiment of the invention will now be described in the context of image processing.

With reference to FIG. 7, there is shown an image processing system 700 according to the invention, and including an image classifying data processing apparatus 702 according to a second embodiment of the invention. The image processing system 700 includes an image capture device 704 including various conventional optical components and an image sensor or capture device, such as a charge couple device (CCD). Hence, in this described embodiment, each of the detectors of the CCD can be considered a separate sensor. The image capturing device 704 may include circuitry 706 for carrying out various image processing techniques on the raw captured image data. Arrow 708 illustrates light from a private object being received by the imaging system 700. The classifier data processing apparatus 702 includes a data processing unit 720 in communication with a data store 722 similarly to the first embodiment. The image processing system 700 may include further ancillary systems or devices such as device 710. Device 710 is in communication with a first output of the data processing unit 720 for receiving a control signal therefrom. As illustrated in FIG. 7, processed image data is output from the image capture device 704 to an input of the data processing apparatus 720.

FIG. 8 shows a schematic graphical representation of a frame 800 of image data as captured by the image capture device 704. As will be appreciated, the frame 800 of image data comprises a plurality of pixels, arranged in rows and columns. The number of pixels in each row and column will depend on the sensitivity of the image sensor. The frame 800 of image data is broken down into an array of sub areas, or bins, as illustrated by dashed lines in FIG. 8. FIG. 8 illustrates an arrangement comprising an array of three rows of four columns giving twelve bins in total. In general, any array of n rows by m columns is possible giving a total number of bins, p=n×m. Generally, at least one of n or m is greater than 1. Other arrangements are possible, for example a three by three array (i.e. n=m=3). It has been found that by binning an image frame into sub regions, feature classification in images is enhanced, compared to analysing an image frame as a whole. This is particularly the case where the bin size corresponds generally to the size of an object or landmark, to be classified.

The data items delivered by the image processing unit 706 to the data processing apparatus 720 may be chosen to reflect the nature of any particular classification task. The image processing unit may be considered as a pre-processing unit, configured so as to deliver useful data items. The data processing unit 720 has no concept of the meaning of the data items, rather it acts simply as a classifier.

For example as described above, each image frame may be considered as a single entity or may be divided into a set of bins, each one being a single entity. Then for each entity, a range of numerical data items may be calculated. These data items may, for example, be the average values of each of the red, green and blue signals (RGB) for each such entity. Alternatively the data items may be derived such as the average values of hue, saturation and brightness value (HSV) for each entity. Equally the data items may be grey scale values. It will be understood that other techniques of “binning” the image may be used, and various image processing algorithms may be used, so that a range of appropriate data items may be derived from the original captured image. Suitable methods and transformations include those found in tools such as Photoshop and the like, and/or as described in “Pattern Recognition and Machine Learning” incorporated by reference above.

Additionally the image processing unit may extract features from the data using well known techniques such as principal component analysis (PCA), GiST (as described in A. Oliva, A. Torralba, “Modelling the shape of the scene: a holistic representation of the Spatial Envelope”, International Journal of Computer Vision, 42: 145-175, 2001, which is incorporated herein by reference for all purposes) and the like.

FIG. 9 shows a graphical representation of a second embodiment of a data structure 900 storing a number of data items used in the second embodiment of the classification method. Data structure 900 is similar to data structure 200, but is in the form of a single table having a plurality of rows, e.g. row 901, each corresponding to a different class, e.g. C1, C2, C3. Each row includes a plurality of fields for storing data values, including a plurality of arithmetic mean feature data items 906, one for each supplied data item. Fields 908 to 918 store recursively calculated statistical parameters corresponding to data items 222 to 232 as illustrated in FIG. 2 above. Table 900 includes a field 902 for storing a data item indicating the number of data samples that have been classified in a particular one of the classes. Table 900 also includes a field 904 for storing a classification data item which represents which of the plurality of possible classes the received data has caused the system to been classified to. The class data item stored in field 904 may simply be a class identified (e.g. C1, C2, C3, etc. up to Cn) or may be an actual class label. A separate row of data structure 900 is provided for each class into which an image frame can be classified. When new classes are identified by the system, then a new row is added to table 900.

With reference to FIG. 10, there is shown a flow chart illustrating a general image classification data processing method 1000 according to a second embodiment of the invention. Method 1000 begins at step 1002 at which the image sensor of the image capture device 704 captures a frame of image data. At step 1004, a current frame of image data is selected for processing. At step 1006, a bin of the first frame of image data can optionally be selected for processing. As discussed above, the data items may be any values derived directly or indirectly from the image. At step 1008, one or more image processing methods can be applied to the image data 1012. At least one of the image processing operations applied extracts a plurality of features (X1 to Xn) from the image. For example, the image processing operation may be a principal component analysis (PCA) operation which derives a plurality of image feature ranked by their importance.

A next bin of the current frame is optionally selected at step 1010 for processing and processing loops 1014 in this way until all of the bins of the current image frame have been processed. Classification of the current image frame is then carried out at step 1016. Then, at step 1018, a next image frame, in this instance, the second, is selected for processing and processing returns, as illustrated by process flow line 1020, to step 1004 at which the second image frame is selected for processing. Hence, as images are provided by the image capture device, each image frame is processed on a frame by frame basis in order to classify each of the image frames. Hence, it will be appreciated that the general method 1000 can be applied both to video data or to non-sequentially captured still images. In an alternative embodiment, processing and classification is carried out on a whole frame basis, rather than using bins, and so steps 1006, 1010 and 1014 are omitted from the process illustrated in FIG. 10.

The image classification step 1016 uses a method essentially the same as classification method 500 and so significant differences therein only will be described. Instead of a data sample being a set of sensor outputs S1 to Sn, the image classification method uses a plurality of image features X1 to Xn which maybe directly or indirectly obtained from a frame of image data. Each frame is initially classified and new classes can be added to table 900 by adding rows. During training actual class labels can be input (e.g. car, lorry, plane) to be associated with the different classes of image identified by the classifier. As the mean values of the data items are recursively calculated and updated in field 906 of table 900 for the row corresponding to the determined class and the statistical parameters are similarly recursively calculated and the updated in the corresponding fields, 908 to 918 of the same row of table 900. The classification assigned to the frame of video data is indicated by field 904. For example, a frame may be classified as relating to one of multiple different types of objects, for example, a car, lorry, plane or unknown. In other embodiments, for example, parts of the landscape which stand out from the surrounding can be classified as landmarks and used for navigation, simple maps, arranging rendezvous for mobile robots or for video diaries.

Once the classification has been determined the method can determine whether any output is required based on the classification assigned to the currently considered frame. One output can be to set the current frame as a ‘landmark’ and assign to it an ID incrementally from a previous ID: ID(K)=ID(k−1)+1. This can then be used for simple map building, navigation, rendezvous, video diaries, etc. If it is determined that an output is required in response to the determining classification, then the data processing apparatus 720 can output a signal to control or otherwise interact with the image capture system 700. For example, an alert signal or trigger signal may be issued, causing further or other data to be captured or displayed. If no further output beyond storing the classification for the image frame is required, then no further output signal may be generated.

Generally, embodiments of the present invention, and in particular the processes involved in the identification of anomalous states of the system employ various processes involving data processed by, stored in or transferred through one or more computing or data processing devices. Embodiments of the present invention also relate to an apparatus, which may include one or more individual data processing devices, for performing these operations. This apparatus may be specially constructed for the required purposes, or it may be a general-purpose computer or data processing device, or devices, selectively activated or reconfigured by a computer program and/or data structure stored in the computer or devices. The processes presented herein are not inherently related to any particular computer or other apparatus. In particular, various general-purpose machines may be used with programs written in accordance with the teachings herein, or it may be more convenient to construct a more specialized apparatus to perform the required method steps.

In addition, embodiments of the present invention relate to computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

FIG. 12 illustrates a typical computer system that, when appropriately configured or designed, can serve as an apparatus of this invention. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers and microprocessors such as programmable devices (e.g., CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner Both of these primary storage devices may include any suitable computer-readable media such as those described above. A mass storage device 908 is also coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 can also be coupled to an interface 910 that can connect to one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications network using an external connection as shown generally at 912. With such a connection, it is contemplated that the CPU might receive information from the network, or might output information to the network in the course of performing the method steps described herein.

Although the above has generally described the present invention according to specific processes and apparatus, the present invention has a much broader range of applicability. In particular, aspects of the present invention are not limited to any specific type of industrial system and can be applied to virtually any type of industrial system in which one or more sensors are available to provide time series data relating to one or more properties of the system. One of ordinary skill in the art would recognize other variants, modifications and alternatives in light of the foregoing discussion.

1. A system, the system comprising:
at least one operative part;
at least one sensor which can output a set of data items representing a property of the operative part; and
a data processing apparatus for classifying the state of the system and in communication with the sensor to receive data items from the sensor, wherein the data processing apparatus comprises a data processing device and a storage device in communication with the data processing device, the storage device storing computer program code executable by the data processing device to:
receive a current data item representing a property of the system;
classify the system as being in one of a plurality of different classes based on the probability that the system is in any one of the plurality of classes calculated using the current data item, a recursively calculated mean value for the set of data items representing the property of the system and at least one recursively calculated statistical parameter for the set of data items representing the property; and
determine whether to output a signal based on the class in which the system is classified.

2. A system as claimed in claim 1, wherein the data processing apparatus has an output which is in communication with the system to output the signal to the system.

3. A system as claimed in claim 1, wherein the operative part comprises an image sensor.

4. A method for classifying the state of a system, wherein the state of the system can be in one of a plurality of different classes, the system having at least one property represented by a set of data items, the method comprising:
receiving a current data item representing a property of the system;
classifying the system as being in one of a plurality of different classes based on the probability that the system is in any one of the plurality of classes calculated using the current data item, a recursively calculated mean value for the set of data items representing the property of the system and at least one recursively calculated statistical parameter for the set of data items representing the property; and
determining whether to output a signal based on the class in which the system is classified.

5. The method as claimed in claim 4, and further comprising:
recursively calculating and storing an updated mean value for the data item representing the property of the system using the current data item; and
recursively calculating and storing a plurality of updated statistical parameters for the set of data items representing the property.

6. The method as claimed in claim 4, and further comprising:
receiving an input of an actual class of the system for the current data item.

7. The method as claimed in claim 6, and further comprising:
setting the actual class of the system to the input actual class, or else to the class that the system was classified as being in.

8. The method as claimed in claim 4 and further comprising:
maintaining a data structure which stores, for each of the plurality of classes, data items representing the recursively calculated mean, the recursively calculated statistical parameters and the associated class of the system.

9. The method as claimed in claim 4, and further comprising: creating a new data structure storing data items representing the recursively calculated mean, the recursively calculated statistical parameters and the associated class of the system when it is determined that the system is in a class which does not correspond to any previous class.

10. The method as claimed in claim 5, wherein the recursive calculating and storing is only carried out if either an actual class has been input or no actual class has been input and there is a low classification error associated with the class in which the system has been classified.

11. The method as claimed in claim 4, wherein each recursive calculation uses a previously stored value representing all of the data items received previously to the current data item.

12. The method as claimed in claim 4, wherein the statistical parameters include the covariance matrix, the inverse of the covariance matrix and the determinant of the covariance matrix.

13. The method as claimed in claim 12, wherein a normalised outer product of all previously received data items and a measure of the average of the current data item is used to calculate the statistical parameters.

14. The method as claimed in claim 4, wherein the system has a plurality of properties each represented by a set of data items and wherein:
a current data item representing each property of the system is received and wherein classifying the system as being in one of a plurality of different classes is based on the probability that the system is in any one of the plurality of classes calculated using the current data item representing each property of the system.

15. A method as claimed in claim 4, wherein the system includes one or more sensors for outputting one or more sets of data items representing one or more properties of the system.

16. The method of claim 4, wherein the signal is selected from: a control signal; a data signal; a feedback signal; an alarm signal; a command signal; a warning signal; an alert signal; a servo signal; a trigger signal; a data capture signal; and a data acquisition signal.

17. The system of claim 1, wherein the system is an electrical or electro-mechanical system.

18. The method of claim 16, wherein the system is a video system, the sensor is an image sensor and the set of data items comprises image data.

19. The method of claim 18, wherein the property relates to a sub-region of a frame of image data.

20. The method of claim 18 and further comprising:
processing the image data to extract one or more image features.

21. The method as claimed in claim 4, wherein the method includes recursively calculating a covariance matrix, and further comprising:
occasionally regularising the covariance matrix to avoid singularity of the covariance matrix.

22. The method of claim 4, wherein the method is a real-time method.

23. A data processing apparatus for classifying the state of a system, comprising:
a data processing device; and
a storage device in communication with the data processing device, the storage device storing computer program code executable by the data processing device to carry out the method of claim 4.

24. A computer readable medium storing computer program code executable by a data processing device to carry out the method of claim 4.
